(19) United States
(12) Patent Application Publication
(10) Pub. No.: US 2009/0237496 A1
(43) Pub. Date: Sep. 24, 2009

(54) SUBSTRATE FOR OBSERVATION AND OBSERVATION SYSTEM

(75) Inventors: Yohei YAMAZAWA, Nirasaki-shi (JP); Chishio Koshimizu, Nirasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/407,476

(22) Filed: Mar. 19, 2009

Related U.S. Application Data
(60) Provisional application No. 61/092,562, filed on Aug. 28, 2008.

(30) Foreign Application Priority Data
Mar. 24, 2008 (JP) 2008-075604

(51) Int. Cl. H04N 7/18

(52) U.S. Cl. 348/61; 348/E07.085

(57) ABSTRACT

An observation substrate for observation capable of observing an overall plasma emission distribution. An observation wafer for observing a plasma emission state in a processing space of a process module of a substrate processing system includes a base and a plurality of image pickup units disposed on a surface of the base facing the processing space. Each of the image pickup units includes a lens and an image pickup device having a memory for storing a picked-up image.

### BACKGROUND OF THE INVENTION

1. Field of the Invention

The present invention relates to a substrate for observation and an observation system, and more particularly, to an observation substrate for observing a state of emission of plasma in a processing chamber.

2. Description of the Related Art

In a prior art substrate processing system that comprises a processing chamber in which a substrate, e.g., a semiconductor wafer is housed and processed using plasma, a plasma is generated from a processing gas in the processing chamber after the inside of the chamber is depressurized. In the substrate processing system of this type, an abnormality of plasma, e.g., an ununiform plasma distribution, sometimes occurs due to generation of abnormal discharge, consumption of component parts inside the processing chamber, adherence of deposits on component parts in the processing chamber, etc. Since abnormality of plasma greatly affects on results of processing on wafers, it is important to identify and remove the cause of abnormality of plasma.

After occurrence of abnormal discharge, a burnt mark which can be visually confirmed is left on a component part within the processing chamber. Consumption of component parts in the processing chamber and adherence of a large amount of deposit on component parts can also be easily visually confirmed. Conventionally, therefore, when an abnormality of plasma occurs, an operator stops the substrate processing system, detaches a lid of the processing chamber from the chamber, and visually confirms a state inside the processing chamber.

However, the pressure inside the processing chamber must be resumed to an atmospheric pressure in order to detach the lid from the processing chamber, and the lid must be attached to the chamber after completion of visual inspection. Since it takes a long time (e.g., two or three hours) to depressurize the inside of the processing chamber, the rate of operation of the substrate processing system is lowered.

Since, as describe above, a change occurs in plasma emission state in the processing chamber due to occurrence of abnormal discharge, etc., it is known to identify the cause of abnormality of plasma based on a result of observation of plasma emission state.

For the observation of plasma emission state in the processing chamber, a small-sized camera can be disposed within the processing chamber, but there is a fear that abnormal discharge begins at the camera. Also known is an observation wafer having an embedded thermocouple to measure the temperature inside the processing chamber (see, for example, “Wafer Surface Temperature Detection Wafer (MODEL TCW-800/MODEL TCW-1400)” on the web page of Hugle Electronics Inc., searched Mar. 3, 2008 on the Internet <URL:http://www.hugle.co.jp/index.html>). Thus, it may be possible to embed a camera into the observation wafer, instead of the thermocouple. In that case, however, lead wires for data readout required to connect the thermocouple with an external temperature measurement unit still remain in the resultant observation wafer having the embedded camera instead of the thermocouple, making it difficult for the observation wafer to be conveyed in the substrate processing system.

At present, therefore, observation of plasma emission state in the processing chamber is carried out externally through a window (e.g., view port) formed in the processing chamber, without the lid of the processing chamber being detached from the chamber.

However, an abnormal discharge, consumption of component parts in the processing chamber, and adhesion of large amount of deposit to component parts in the chamber take place locally. It is therefore necessary to observe an overall plasma emission distribution in the processing chamber in order to identify the cause of abnormal plasma. On the other hand, the window of the processing chamber is generally small in size and only permits the observation of plasma from lateral side, making it difficult to observe the overall plasma emission distribution.

### SUMMARY OF THE INVENTION

The present invention provides a substrate for observation, i.e., an observation substrate and an observation system capable of observing an overall plasma emission distribution.

According to a first aspect of this invention, there is provided an observation substrate for observing a plasma emission state within a processing chamber, which comprises a plurality of image pickup units disposed on a surface of the observation substrate adapted to face an interior of the processing chamber, wherein the plurality of image pickup units each include a lens and an image pickup device, and the plurality of image pickup units include at least one memory for storing a picked-up image.

With the observation substrate of this invention, each of image pickup units disposed on a surface of the observation substrate facing the interior of the processing chamber includes a lens and an image pickup device, and it is therefore possible to observe an overall plasma emission distribution in a space facing the surface of the observation substrate. In addition, a picked-up image is stored into the memory of the image pickup devices and can be taken out therefrom after the observation substrate is transferred out from the processing chamber. Therefore, it is unnecessary to provide lead wires for data readout. Furthermore, since a plasma emission state can be observed only by transferring the observation substrate into the processing chamber, it is possible to eliminate the need of detaching a lid of the processing chamber from the chamber, whereby a reduction in the rate of operation of the substrate processing system can be prevented.

In the observation substrate of this invention, the plurality of image pickup units can be arranged in an array.

With this observation substrate, the image pickup units are arranged in an array, and it is therefore possible to fully observe the overall plasma emission distribution in a space facing the surface of the observation substrate.

The lens of each of at least part of the plurality of image pickup units can be slanted relative to the surface of the observation substrate.

With the above observation substrate, since at least part of the image pickup units each include a lens slanted relative to the surface of the observation substrate, it is possible to observe a plasma emission state in a space other than the space perpendicularly facing the surface of the observation substrate.

The memory of the plurality of image pickup units can be adapted to store a moving image.

With the above observation substrate, since the memory of the image pickup units stores a moving image, it is possible to observe a time-dependent change in plasma emission state.

The observation substrate can include at least one switch adapted to cause the plurality of image pickup units to start image pickup after elapse of a predetermined time period.

With the above observation substrate, since the observation substrate has the switch for causing the plurality of image pickup units to start image pickup after elapse of a predetermined time period, it is possible to observe a plasma emission state after elapse of the predetermined time period from when the observation substrate is transferred into the processing chamber.

The switch can be adapted to be turned on after being charged with a predetermined amount of charge.

With the above observation substrate, since the switch is turned on after it is charged with a predetermined amount of charge, it is possible to turn on the switch simply by transferring the observation substrate into the processing chamber and exposing the switch to plasma so that the switch is charged with the predetermined amount of charge by the plasma. It is therefore unnecessary to provide the switch with a timer or the like, making it possible to simplify the construction of the switch.

The observation substrate can further include spectrometers each disposed between the lens and the image pickup device of a corresponding one of the plurality of image pickup units.

With the observation substrate, since the image pickup units further include spectrometers interposed between the lenses and the image pickup devices of the image pickup units, incoming light from plasma can be spectrally analyzed to thereby make it possible to analyze plasma components to identify the cause of abnormal plasma in more detail.

The observation substrate can further include a plurality of laser oscillators disposed on the surface of the observation substrate.

With this observation substrate, the laser oscillators are disposed on the surface of the observation substrate, and irradiate laser beams toward the plasma. The image pickup units receive incoming light from the plasma due to the irradiation of laser beams and pick up an image of a plasma emission state. Thus, a clearer image can be picked up as compared to an image based on light spontaneously emitted from the plasma.

The lens of each of the plurality of image pickup units can include a protective film formed on its surface.

With this observation substrate, since the lens of each image pickup unit has its surface formed with a protective film, it is possible to prevent the lens from being consumed by plasma even when the observation of plasma emission state is repeated.

According to a second aspect of this invention, there is provided an observation system having an observation substrate for observing a plasma emission state within a processing chamber, and a container for housing the observation substrate, wherein the observation substrate includes a plurality of image pickup units disposed on a surface of the observation substrate adapted to face an interior of the processing chamber, the plurality of image pickup units each include a lens and an image pickup device, and the plurality of image pickup units include at least one memory for storing a picked-up image, and the container includes an image readout unit adapted to read out the image stored in the memory of the plurality of image pickup units, and a display unit adapted to display the image read out therefrom.

With the observation system of this invention, the image pickup units disposed on a surface of the observation substrate facing the interior of the processing chamber each include a lens and an image pickup device, and it is therefore possible to observe an overall plasma emission distribution in a space facing the surface of the observation substrate. In addition, a picked-up image is stored into the memory of the image pickup units and can be taken out therefrom after the observation substrate is transferred out from the processing chamber. Therefore, it is unnecessary to provide lead wires for data readout. Furthermore, since a plasma emission state can be observed only by transferring the observation substrate into the processing chamber, it is possible to eliminate the need of detaching a lid of the processing chamber from the chamber, whereby a reduction in the rate of operation of the substrate processing system can be prevented. Since the image read out from the memory of the image pickup units of the observation substrate is displayed by the display unit of the container, an overall plasma emission distribution can be confirmed immediately after the observation substrate is transferred out from the processing chamber, making it possible to rapidly identify the cause of abnormal plasma.

Further features of the present invention will become apparent from the following description of exemplary embodiments with reference to the attached drawings.

### BRIEF DESCRIPTION OF THE DRAWINGS

FIG. 1 is a plan view schematically showing the construction of a substrate processing system to which an inspection system according to one embodiment of this invention;

FIG. 2 is a section view schematically showing the construction of a process module in FIG. 1;

FIG. 3A is a plan view schematically showing the construction of an observation wafer as an observation substrate according to one embodiment of this invention, and FIG. 3B is a fragmentary enlarged section view showing a circumferential edge portion of the observation wafer;

FIG. 4 is a section view schematically showing the construction of an observation FOUP capable of housing the observation wafer in FIG. 3;

FIG. 5A is a fragmentary enlarged section view showing a first modification of the observation wafer in FIG. 3, FIG. 5B is a view showing a second modification thereof, and FIG. 5C is a view showing a third modification thereof;

FIG. 6 is a fragmentary enlarged section view schematically showing the construction of an observation wafer as an observation substrate according to a second embodiment of this invention; and

FIG. 7 is a fragmentary enlarged section view schematically showing the construction of an observation wafer as an observation substrate according to a third embodiment of this invention.

### DETAILED DESCRIPTION OF THE PREFERRED EMBODIMENTS

The present invention will now be described in detail below with reference to the drawings showing preferred embodiments thereof.

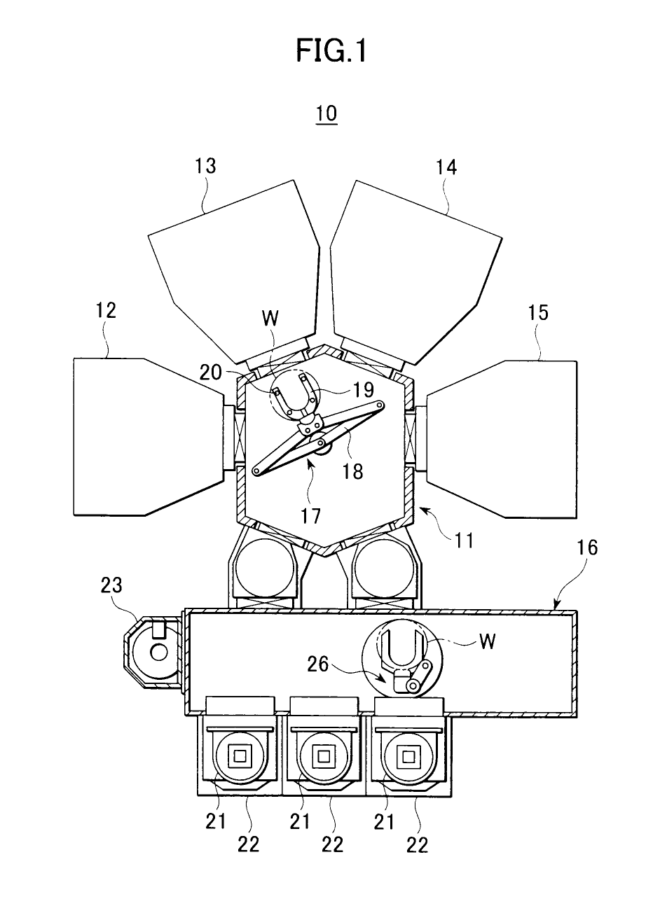

FIG. 1 schematically shows in plan view the construction of a substrate processing system to which an inspection system according to one embodiment of this invention is applied.

As shown in FIG. 1, the substrate processing system 10 includes a transfer module 11 having a hexagonal shape as viewed in plan, four process modules 12 to 15 radially arranged around the transfer module 11, and a loader module 16 as a rectangular shaped common transfer chamber.

The process modules 12 to 15 are substrate processing apparatuses each for performing predetermined processing on a semiconductor device substrate (hereinafter referred to as wafer) W. For example, the process module 12 is an etching processing apparatus that performs etching processing on the wafer W using a plasma.

In the substrate processing system 10, the pressures within the transfer module 11 and the process modules 12 to 15 are maintained at vacuum, whereas the pressure within the loader module 16 is maintained at atmospheric pressure.

The transfer module 11 has disposed therein a frog leg-type substrate transfer unit 17 that can bend/elongate and turn. The substrate transfer unit 17 includes an arm 18 able to horizontally expand and contract and rotatable, and a bifurcated transfer form 19 coupled to a tip end of the arm 18 and supporting a wafer W. The substrate transfer unit 17 transfers a wafer W between the process modules 12 to 15. The transfer fork 19 has a plurality of protruding taper pads 20 adapted to be in contact with the periphery of the wafer W and stably support the wafer W.

The loader module 16 is connected to three FOUP mounting stages 22 each mounted with a FOUP (front opening unified pod) 21, which is a container for housing, e.g., twenty-five wafers W, and is connected to an orienter 23 that pre-aligns the position of each wafer transferred out from the FOUP 21. The loader module 16 includes a substrate transfer unit 26 disposed therein for transferring the wafer W to a desired position.

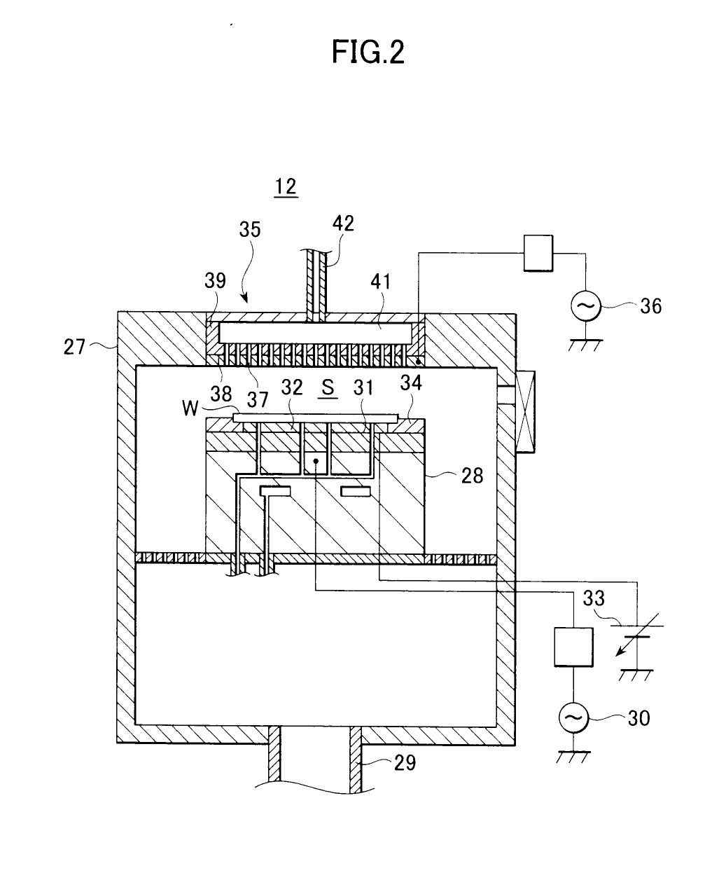

FIG. 2 schematically shows in section view the construction of the process modules 12 to 15 in FIG. 1. These modules 12 to 15 are the same in construction as one another, and the following is a description of the process module 12.

As shown in FIG. 2, the process module 12 has a chamber 27 (processing chamber) for housing a wafer W having a diameter of, for example, 300 mm. In the chamber 27, a cylindrical susceptor 28 is disposed on which the wafer W is placed. The chamber 27 is connected with an exhaust pipe 29 to which a TMP (turbo molecular pump) and a DP (dry pump), none of which are shown, are connected. These pumps vacuum and depressurize the inside of the chamber 27.

A lower high-frequency power source 30 is connected to the susceptor 28 in the chamber 27 and supplies the susceptor 28 with predetermined high frequency electric power. On an upper portion of the susceptor 28, there is disposed a table-like electrostatic chuck 32 incorporating an electrostatic electrode plate 31 to which a DC power source 33 is electrically connected. When a positive DC voltage is applied to the electrostatic electrode plate 31, the wafer W is attracted and held on an upper surface of the electrostatic chuck 32 through a Coulomb force or a Johnsen-Rabek force.

On the electrostatic chuck 32, an annular focus ring 34 is disposed such as to surround the wafer W attracted to and held on the chuck 32. The focus ring 34 is made of a conductive member, e.g., silicon, and converges plasma in a processing space S defined between the susceptor 28 and a shower head 35, described later, toward the surface of the wafer W to improve the efficiency of etching processing.

In a ceiling portion of the chamber 27, the shower head 35 is disposed so as to face the susceptor 28. An upper high-frequency power supply 36 is connected to the shower head 35 and supplies it with predetermined high-frequency power. The shower head 35 includes a disk-shaped ceiling electrode plate 38 formed with a number of gas holes 37, and a cooling plate 39 that supports the ceiling electrode plate 38 hanging therefrom. The shower head 35 functions as a lid for the chamber 27 and can be detached from the chamber 27.

A buffer chamber 41 is defined within the cooling plate 39 of the shower head 35. A processing gas introduction pipe 42 is connected to the buffer chamber 41 to which a processing gas, e.g., a mixture gas containing a gas of CF system, is supplied from the gas introduction pipe 42. The shower head 35 supplies the processing gas to the processing space S via the gas holes 37.

In the process module 12, the processing gas is supplied to the processing space S as described above, and high-frequency power is also applied to the processing space S by the susceptor 28 and the shower head 35, whereby a plasma is generated from the processing gas. Using the plasma, etching processing is performed on the wafer.

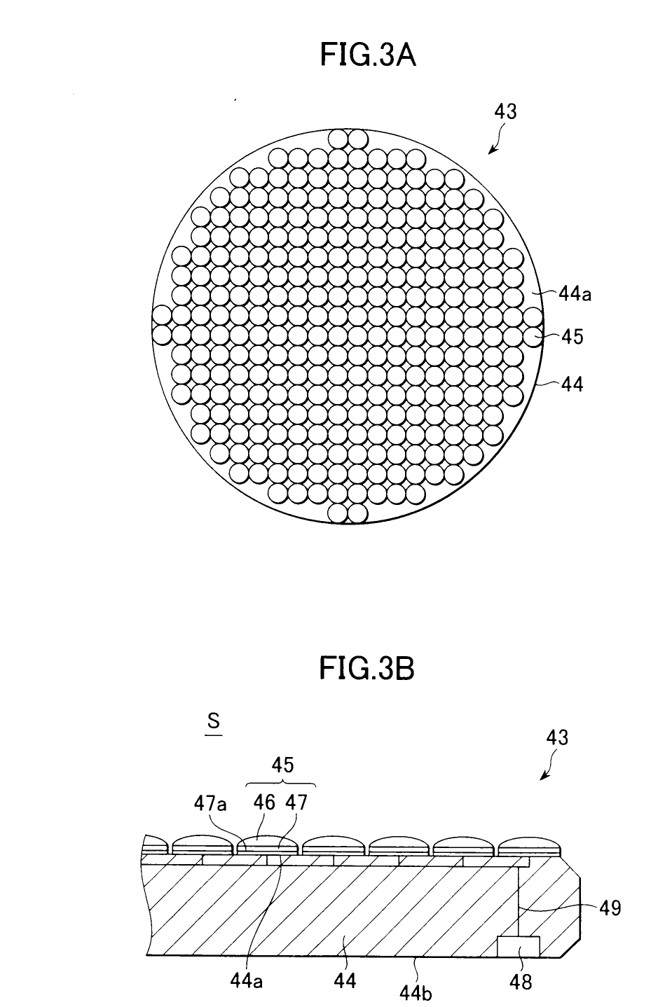

FIG. 3A schematically shows in plan view the construction of an observation wafer as an observation substrate of this embodiment, and FIG. 3B shows in enlarged section view a circumferential edge portion of the observation wafer.

As shown in FIGS. 3A and 3B, the observation wafer 43 includes a disk-shaped base 44 made of silicon and having a diameter of, e.g., 300 mm, and a plurality of image pickup units 45 disposed on a surface 44a of the base 44 facing the processing space S. The image pickup units 45 are disposed in an array so as to cover the entirety of the surface 44a of the base 44.

The image pickup units 45 each include a lens 46 made of, e.g., quartz and disposed to face the processing space S and an image pickup device (for example, a CMOS sensor or a CCD sensor) 47 interposed between the lens 46 and the surface 44a of the base 44. The image pickup device 47 has a memory 47a. Each image pickup unit 45 picks up an image of a plasma emission state in a portion of the processing space S to which the image pickup unit 45 faces, and stores data of the picked-up image of emission state into the memory 47a. As described above, the image pickup units 45 cover the entirety of the surface 44a of the base 44, and are therefore able to pick up an overall plasma emission distribution in the processing space S facing the observation wafer 43.

Abnormality of plasma sometimes takes place after the elapse of a predetermined time period from when the plasma is generated in the processing space S. In this embodiment, therefore, the memories 47a of the image pickup devices 47 have a capacity large enough to be able to store a moving image, making it possible to observe a time-dependent change in plasma emission state and identify the cause of abnormality of plasma. It should be noted that at least one memory common to the image pickup devices 47 of the image pickup units 45 may be used, instead of using the memories 47a respectively provided in the image pickup devices of the image pickup units 45.

On a rear surface 44b at a circumferential edge portion of the observation wafer 43, there is disposed an output terminal 48 from which image data stored in the memories 47a of the image pickup devices 47 are read out to the outside. The image pickup devices 47 are connected to the output terminal 48 via wiring 49.

In the observation wafer 43, the image pickup devices 47 of the image pickup units 45 are bonded to the base 44, and the lenses 46 are bonded to respective ones of the image pickup devices 47. The observation wafer 43 has a thickness at a maximum of 2 mm in consideration of transferability of the observation wafer 43 in the substrate processing system 10. The base 44 may not be made of silicon but made of quartz.

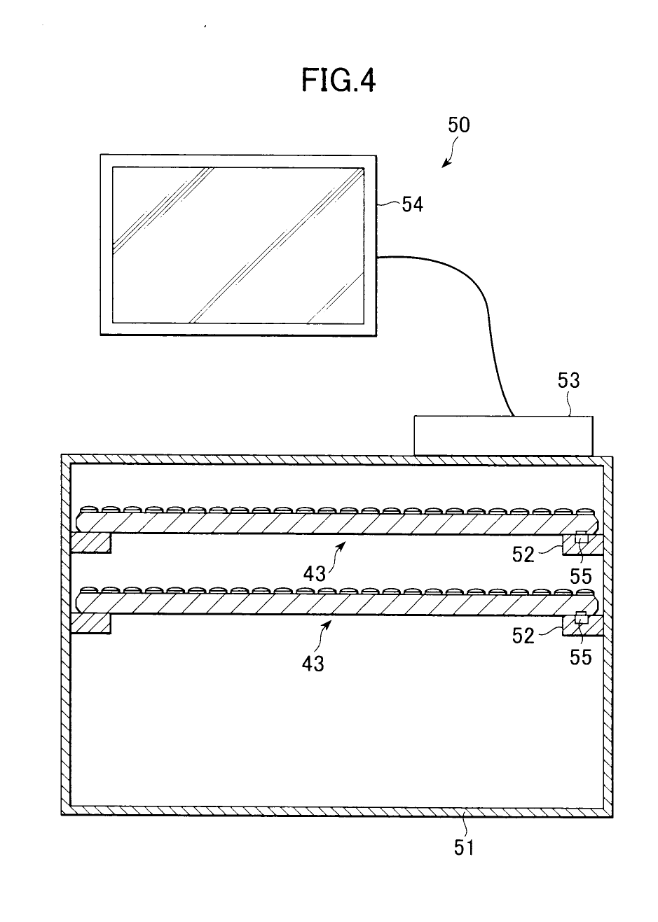

FIG. 4 schematically shows in section view the construction of an observation FOUP capable of housing a plurality of observation wafers 43 in FIG. 3. The observation FOUP has the same outer profile as that of the FOUP 21 for wafers W, and can be placed on each of the FOUP mounting stages 22.

As shown in FIG. 4, the observation FOUP 50 (container) includes a housing body 51, support members 52 projecting from a side wall of the body 51 so as to support circumferential edge portions of the observation wafers 43 within the body 51, a computer 53 (image readout unit) that processes image data read out from the memories 47a of the image pickup units 45 of the observation wafer 43, and a display 54 (display unit) that displays the processed image.

In the observation FOUP 50, the support members 52 each have a readout terminal 55 disposed in contact of the output terminal 48 of the observation wafer 43 concerned, the computer 53 reads out data of the picked-up image of a plasma emission distribution from the memories 47a of the image pickup units 45 of each observation wafer 43 via the readout terminal 55, and the display 54 displays an image of an overall plasma emission distribution.

In this embodiment, the observation wafers 43 and the observation FOUP 50 constitute an observation system.

With the observation wafer 43 as the observation substrate of this embodiment, the image pickup units 45 disposed on the surface 44a of the base 44 facing the processing space S each have the lens 46 and the image pickup device 47, and these image pickup units 45 are disposed in an array to cover the entirety of the surface 44a of the base 44, whereby an overall plasma emission distribution in the processing space S can be fully observed. Since the image pickup devices 47 store a picked-up image into memories, the picked-up image can be taken out after the observation wafer 43 is transferred out from the chamber 27, and lead wires for data readout can be eliminated. Furthermore, since a plasma emission state can be observed only by transferring the observation wafer 43 into the chamber 27, it is possible to eliminate the need of detaching the shower head 35 from the chamber 27, whereby a reduction in the rate of operation of the substrate processing system 10 can be prevented.

With the observation FOUP 50 of the observation system of this embodiment, the display 54 displays an image read out from the memories 47a of the image pickup units 45 of the observation wafer 43, the overall plasma emission distribution can be confirmed immediately after the observation wafer 43 is transferred out from the chamber 27, making it possible to rapidly identify the cause of abnormality of plasma.

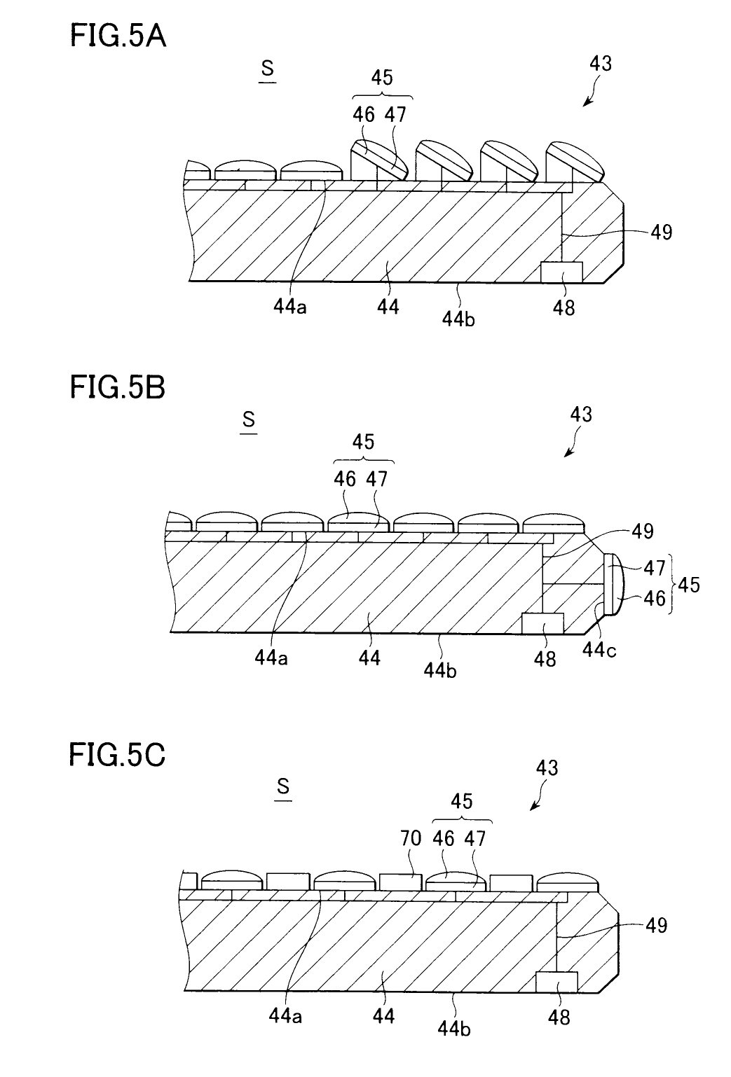

In the observation wafer 43, the lenses 46 of the image pickup units 45 are disposed to face the processing space S. Alternatively, the lenses 46 and image pickup devices 47 of some of the image pickup units 45 may be slanted relative to the surface 44a of the base 44 (see, FIG. 5A) In that case, a plasma emission state in a space not perpendicularly facing the surface 44a of the base 44 can be observed. The observation wafer 43 can include image pickup units 45 provided on a side portion 44c of the base 44 (see, FIG. 5B). In that case, a plasma emission state in a broad range beyond the processing space S can be observed.

In the observation wafer 43, the memories 47a have a capacity large enough to be able to store a moving image in order to observe an abnormality of plasma which can take place after elapse of a predetermined time period from when the plasma is generated in the processing space S. Instead of setting the memory capacity large enough to store a moving image, there may be provided at least one switch for causing the image pickup units 45 to start image pickup after elapse of a predetermined time period. In an example shown in FIG. 5C, a plurality of switches 70 corresponding in number to the image pickup unit 45 are each disposed and electrically connected between the image pickup device 47 and the memory 47a of a corresponding image pickup unit 45. When the switches 70 are turned ON, storage of an image picked up by the image pickup devices 47 into the memories 47a is started. Thus, an abnormality of plasma generated after the elapse of the predetermined time period can be observed. Preferably, the switches are each configured by a capacitor or the like such that it is turned ON after being charged with a predetermined amount of charge. In that case, it is possible to turn ON the switches simply by transferring the observation wafer 43 into the processing space S and exposing the switches of the observation wafer 43 to the plasma so as to be each charged with the predetermined amount of charge. It is therefore unnecessary to provide the switch with a timer or the like, making it possible to simplify the construction of the switch. In stead of the switches 70, a switch having switch portions thereof respectively electrically connected between the image pickup devices 47 and the memories 47a of the image pickup units 45 is disposed at an arbitrary portion of the observation wafer 43.

In each of the image pickup units 45, a protective film may be formed on the surface 44a of the lens 46. In that case, consumption of the lens 46 by plasma can be prevented, even if the observation of plasma emission state is repeated.

In the observation FOUP 50, the computer 53 performs processing on image data read out from the memories of the image pickup units 45. Alternatively, image data may be read out from the memories of the image pickup units 45 and then processed by a computer provided separately from the observation FOUP 50.

Next, a description will be given of an observation substrate according to a second embodiment of this invention.

This embodiment is basically the same in construction and function as the first embodiment. In the following, a description of common constructions and functions is omitted, and only the different constructions and functions are described.

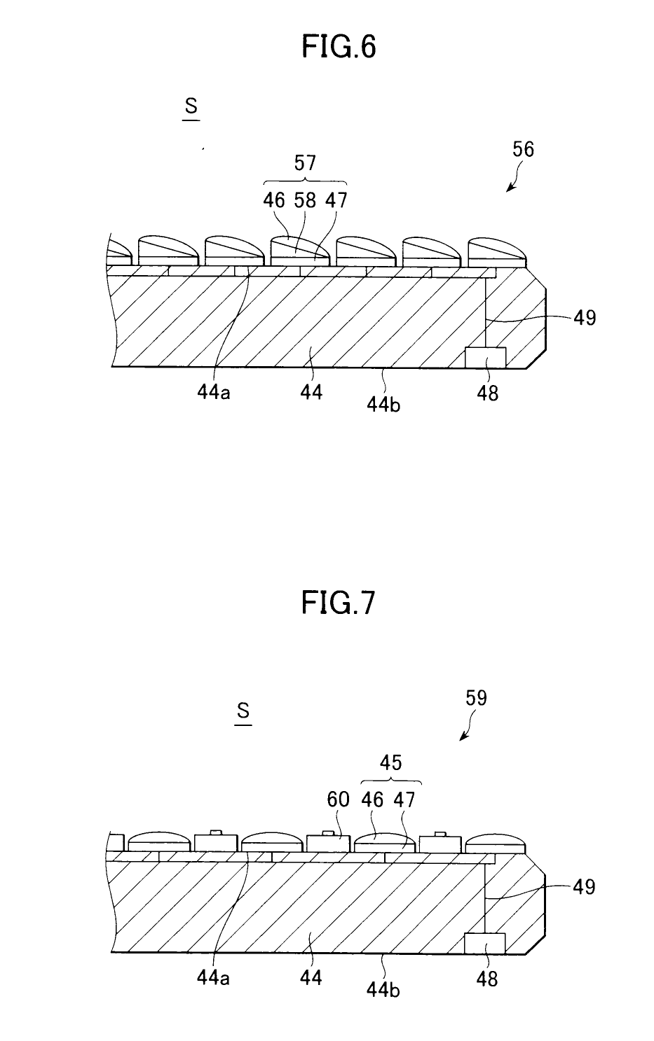

FIG. 6 schematically shows in fragmentary enlarged section view the construction of an observation wafer as an observation substrate of this embodiment.

As shown in FIG. 6, the observation wafer 56 includes a plurality of image pickup units 57 disposed on a surface 44a of abase 44 of the observation wafer 56 facing the processing space S. The image pickup units 57 are disposed in an array so as to cover the entirety of the surface 44a of the base 44. Each image pickup unit 57 includes a lens 46 slanted relative to the surface 44a of the base 44, an image pickup device 47 disposed on the surface 44a of the base 44, and a prism 58 interposed between the lens 46 and the image pickup device 47.

In each of the image pickup units 57, incoming light from plasma in the processing space S passes through the lens 46 and is then spectrally dispersed by the prism 58, and the spectrally dispersed incoming light reaches the image pickup device 47. Data of an image of spectrally dispersed incoming light from the plasma is stored in the memories of the image pickup devices 47. Subsequently, when the observation wafer 56 is housed in the observation FOUP 50, the spectrally dispersed incoming light from the plasma is displayed on the display 54 of the observation FOUP 50. Thus, spectral analysis on the incoming light from the plasma can be carried out with ease.

With the observation wafer 56 as an observation substrate of this embodiment, incoming light from plasma can be spectrally analyzed, making it possible to analyze plasma components and identify in detail the cause of abnormality of plasma.

Next, a description will be given of an observation substrate according to a third embodiment of this invention.

This embodiment is basically the same in construction and function as the first embodiment. In the following, a description of common constructions and functions is omitted, and only the different constructions and functions are described.

FIG. 7 schematically shows in fragmentary enlarged section view the construction of an observation wafer as an observation substrate of this embodiment.

As shown in FIG. 7, an observation wafer 59 includes a plurality of image pickup units 45 disposed on a surface 44a of a base 44 of the observation wafer 59 facing the processing space S, and a plurality of laser oscillators (e.g., semiconductor laser oscillators) 60 disposed on the surface 44a of the base 44 so as to be adjacent to respective ones of the image pickup units 45.

Each of the laser oscillators 60 irradiates a laser beam toward that portion of plasma in the processing space S to which the laser oscillator 60 faces, and the plasma irradiated with laser beam emits light. Each image pickup unit 45 receives incoming light from that part of plasma to which the adjacent laser oscillator 60 faces. Since an amount of incoming light from plasma varies depending on an amount of laser beam irradiated to the plasma, the amount of incoming light from plasma received by each image pickup unit 45 can be increased by increasing an amount of laser beam.

With the observation wafer 59 as an observation substrate of this embodiment, an amount of incoming light from plasma can be adjusted by an amount of the laser beam irradiated on the plasma, and a clearer image can be picked up as compared to an image based on light spontaneously emitted from the plasma, whereby the cause of abnormality of plasma can be identified in more detail.

In the above described embodiments, the image pickup devices 47 of the image pickup units 45 (57) of the observation wafer 43 (56, 59) each have a memory or have at least one common memory. Alternatively, a wireless communication device able to communicate with an external unit may be provided in the observation wafer. In that case, data of picked-up image of plasma emission distribution can be transmitted to the external unit without the need of transferring the observation wafer out from the chamber 27, making it possible to observe realtime the plasma emission distribution in the processing space S. Since high-frequency electric power is applied to the processing space S, the radio wave for communication with the external unit preferably has a frequency different from that of the high-frequency electric power, whereby reliable communication with the external unit can be ensured.

In the embodiments, the plasma emission distribution in the processing space S is observed by the observation wafer 43 (56, 59). Alternatively, a state in the chamber 27 may be observed by the observation wafer 43 (56, 59), without generating plasma in the chamber 27. Further alternatively, a state in the transfer module 11 or in the loader module 16 may be observed. In that case, preferably, the observation wafer 43 (56, 59) is moved to a desired position by the substrate transfer unit 17 or 26.

In the embodiments, a plasma emission distribution at the time of etching processing is observed. Alternatively, there may be observed a plasma emission distribution at other plasma processing, e.g., CVD processing.

In the embodiment, the substrate subjected to etching processing is a semiconductor wafer W, but the substrate to be etched is not limited thereto. For example, the substrate may be a glass substrate for LCD (liquid crystal display) or FPD (flat panel display).

What is claimed is:

1. An observation substrate for observing a plasma emission state within a processing chamber, comprising:
a plurality of image pickup units disposed on a surface of the observation substrate adapted to face an interior of the processing chamber,
wherein said plurality of image pickup units each include a lens and an image pickup device, and
said plurality of image pickup units include at least one memory for storing a picked-up image.

2. The observation substrate according to claim 1, wherein said plurality of image pickup units are arranged in an array.

3. The observation substrate according to claim 1, wherein the lens of each of at least part of said plurality of image pickup units is slanted relative to the surface of the observation substrate.

4. The observation substrate according to claim 1, wherein the memory of said plurality of image pickup units is adapted to store a moving image.

5. The observation substrate according to claim 1, including:
at least one switch adapted to cause said plurality of image pickup units to start image pickup after elapse of a predetermined time period.

6. The observation substrate according to claim 5, wherein said switch is adapted to be turned on after being charged with a predetermined amount of charge.

7. The observation substrate according to claim 1, further including:
spectrometers each disposed between the lens and the image pickup device of a corresponding one of said plurality of image pickup units.

8. The observation substrate according to claim 1, further including:
a plurality of laser oscillators disposed on the surface of the observation substrate.

9. The observation substrate according to claim 1, wherein the lens of each of said plurality of image pickup units includes a protective film formed on its surface.

10. An observation system having an observation substrate for observing a plasma emission state within a processing chamber, and a container for housing the observation substrate, wherein:
the observation substrate includes a plurality of image pickup units disposed on a surface of the observation substrate adapted to face an interior of the processing chamber, the plurality of image pickup units each include a lens and an image pickup device, and the plurality of image pickup device include at least one memory for storing a picked-up image, and
the container includes an image readout unit adapted to read out the image stored in the memory of said plurality of image pickup units, and a display unit adapted to display the image read out therefrom.
